(19) United States
(12) Patent Application Publication
(10) Pub. No.: US 2004/0030623 A1
(43) Pub. Date: Feb. 12, 2004

(54) Momentum bars

(76) Inventor: Danton S. Long, Michigan City, IN (US)

Correspondence Address: NANCY SEAR IATAROLA, 371 SPRING VIEW COURT, PORTER, IN, 46304, US

(21) Appl. No.: 10/216,701

(22) Filed: Aug. 12, 2002

(51) Int. Cl. G06F 17/60

(52) U.S. Cl. 705/35

(57) ABSTRACT

An improved method and system for displaying financial information using a computer is disclosed. A technical analyst chooses a user defined range of data to study and displays the user defined range of data comprising indicia of four transaction prices along a y-axis. The display of the user defined range of data changes only when a transaction price appears outside the user defined range of data. The x-axis comprises a time independent variable in order to discount price distribution patterns that evidence little change, systematize patterns that reveal large changes, and display patterns in a simplified visual summary that reveal when the market is in genuine distribution and development.

### CROSS-REFERENCE TO RELATED APPLICATIONS

Not applicable

### BACKGROUND OF THE INVENTION

(1) Field of the Invention

This invention relates to technical analysis of financial information and in particular to an improved method and system for charting a user defined range of data comprising indicia of four transaction prices only when a trade occurs outside that user defined range of data and without reliance on any time period.

(2) Description of the Related Art Including Information Disclosed Under 37 CFR 1.97 and 1.98

Technical analysts study the past performance of the price of financial investments consisting of securities, cash markets, commodities, futures, options, derivatives, and any other financial transaction data, so they can better predict the future performance of that price. Historically, technical analysts have displayed prices within a bar chart. Usually, the first step in constructing any bar chart is to decide on the time period in which to display the price. The time period may be minutes, days, weeks, months, or years. Typically, technical analysts record high and low prices within the time periods they choose to study.

Technical analysts utilize an abundance of analytical tools to analyze the bar charts. However the standard bar chart which is based on time, limits technical analysts' ability to analyze continual price stream data using standard technical tools.

One system for displaying financial information without regard to time involves point-and-figure charts wherein price increases are indicated with a series of “X” marks and price decreases are indicated with a series of “O” marks. Depending upon the range, point-and-figure charts may reveal every single price change. In addition, you cannot apply many of the standard technical tools to point-and-figure charts including Aroon, Bollinger Banks, Chaiken A/D Oscillator, Chande Momentum Oscillator, various types of Directional Movement, Danton Stop, Klinger Oscillator, MACD, MESA Sine Wave, various types of moving averages, Parabolic SAR, Relative Strength Index, Relative Volatility Index, Stochastic Momentum Index, Stochastic Oscillator, Stochastic Volatility Index, and Williams % R as well as comprehensive tools such as Elliott Wave Analysis.

Another system for charting price movement without regard to time involves Kagi charts which display a series of connecting vertical lines where the direction and thickness of the lines are dependent on price action. Lines within Kagi charts change from thick to thin when the price decreases or from thin to thick when the price increases.

Finally, Renko charts involve vertical boxes whereby the vertical boxes move only if prices move by a minimum amount. One of the limitations of the Renko charts, however, is that they are always based on closing prices. The Renko charts, therefore, exclude a great deal of critical information from the continual price stream data. In addition, you cannot apply many of the standard technical tools including Aroon, Bollinger Banks, Chaiken A/D Oscillator, Chande Momentum Oscillator, various types of Directional Movement, Danton Stop, Klinger Oscillator, MACD, MESA Sine Wave, various types of moving averages, Parabolic SAR, Relative Strength Index, Relative Volatility Index, Stochastic Momentum Index, Stochastic Oscillator, Stochastic Volatility Index, and Williams % R as well as comprehensive tools such as Elliott Wave Analysis.

Financial analysts utilize software programs to track securities, cash markets, commodities, futures, options, derivatives, and any other financial transaction data using a variety of graphical displays. However, existing software programs limit technical analysis of securities, cash markets, commodities, futures, options, derivatives, and any other financial transaction data to studies based on specific units of time. In addition, they display transaction price data via abstract methods, exclude opening and/or closing price information, fail to take distribution into account, and consider every fragment of transaction price information as relevant and meaningful. As a result, these software programs limit technical analysts' ability to conduct meaningful analytical and statistical studies. Further, these limitations restrict technical analysts' ability to grasp a full perspective on developments within the market.

For example, if the Dow Jones Industrial Average moves downward three hundred points in one hour, bar charts based on time periods will only send signals to technical analysis tools after that time period, therefore prohibiting the technical analyst from using technical analysis tools efficiently. The bar chart based on a thirty minute time period would show only two bars and compile only two openings, two highs, two lows, and two closes for the three hundred point move of the Dow Jones Industrial Average in one hour.

However, the invention, wherein the user defined range of data equals five points, would display at least sixty separate succeeding bars, each bar comprising indicia of opening, high, low, and closing prices. The invention will display thirty separate bars for a ten point user defined range of data, each bar again comprising indicia of opening, high, low, and closing prices. As a result, tools of technical analysis that use the invention would respond more quickly, giving the technical analyst definitive signals on which they could act more quickly to initiate a sell if they were long, a sell if they wanted to go short, or a buy when they saw that the downward move was over and that the market was going up again.

When price fluctuates within a relatively narrow range, the invention more accurately depicts price changes than standard time based bar charts. The invention is driven only by price, not time.

### OBJECTS OF THE INVENTION

A primary object of the present invention is to provide a system and method to define, manage, and control a continual stream of price data graphically, by providing the technical analyst a means to observe continuous distribution patterns. The invention discloses the display of user defined range of data comprising indicia of four transaction prices which allows technical analysts to conduct meaningful statistical and technical analysis without reliance on time. The user defined range of data is organized to discount price distribution patterns that evidence little change, systematize patterns that reveal large changes, and display patterns in a simplified visual summary that reveals when the market is in genuine distribution and development. The invention includes necessary data typical statistical and technical analysis studies demand and facilitates the identification of trends in the market, all without reliance on any time period.

On the standard bar chart, if the price opens outside the previous bar's range, the previous bar fails to come back and trade within the previous bar's range. That terminology is referred to as a price gap. The invention displays no price gaps on a chart.

Further objects of the invention include minimizes congestion areas, adapts price anomalies which are volatile price swings, and it enhances the indicator functions. In addition the technical analyst will get better entry and exit signals using the standard technical tools.

Momentum Bars of the invention are unique. They do not appear anywhere in the financial literature. They describe price behavior in a way that has never been done before using standard bar charts. All of the tools of technical analysis (Aroon, Bollinger Banks, Chaiken A/D Oscillator, Chande Momentum Oscillator, various types of Directional Movement, Danton Stop, Klinger Oscillator, MACD, MESA Sine Wave, various types of moving averages, Parabolic SAR, Relative Strength Index, Relative Volatility Index, Stochastic Momentum Index, Stochastic Oscillator, Stochastic Volatility Index, and Williams % R as well as comprehensive tools such as Elliott Wave Analysis or Shock Wave Analysis to give some divergent yet applicable examples) that are applied to current types of bar charts can be applied to Momentum Bar charts.

### SUMMARY OF THE INVENTION

The present invention involves the novel display of the user defined range of data comprising indicia of four transaction prices from the continual stream of price data regarding financial instruments selected from the group consisting of securities, cash markets, commodities, futures, options, derivatives, and any other financial transaction data using a computer. The invention allows the technical analyst to view continuous distribution patterns such that user defined range of data measurements are visually apparent as vertical price bars which contain four necessary data points. This invention allows technical analysts to perform statistical and technical analysis studies without reliance on any arbitrary time period. In an improved embodiment of the present invention, the user defined range of data, which is preferably a user defined price range, is displayed using a computer on a two dimensional graph defined by a time independent x-axis and a y-axis defined by the user defined range of data comprising indicia of an opening price, a closing price, a high price, and a low price.

Price is the only mechanism that markets use to balance or rationalize supply and demand. Price is the predominant market component on which the investors make investment decisions. Therefore, price is the variable on which the display of the invention relies. The invention provides a novel display of the user defined price range comprising indicia of four transaction prices from continual streams of price data that are easily measured and defined.

The present invention does not limit a market's natural development of price to any particular period of time. Price distributions occur over natural time frames, not arbitrary time frames. A market is in genuine development and distribution when price moves are moving in a series of higher highs or lower lows to correct any imbalance perceived by the participants

The user defined range of data displayed on the y-axis is dependent on risk demands and price ranges that evidence genuine distribution and development. The x-axis represents a variable which is independent of time in order to ignore distribution patterns that evidence little or no signs of distribution. The time independent x-axis allows the technical analyst to view genuine and meaningful distribution in a market's trend without the limitations of arbitrary time periods.

First, the technical analyst selects the user defined range of data. The preferred user defined range of data is the user defined price range and depends upon the price range and/or risk the technical analyst wants to study. The price range is not critical. The price range the technical analyst chooses is a function of risk. Obviously, plotting fifty cent increments, will give you less risk than a two dollar increment. The technical analyst may choose $0.02, $0.10, $0.50, $1.00, $2.00, $3.05, or $5.00, or more.

Next the computer reads information from the continual stream of price data. When the technical analyst is ready to begin the display, a first user defined range of data is displayed on the y-axis. The system then waits for information from the continual stream of price data to reveal the next transaction price which is outside the user defined range of data. The transaction price may move in a direction which, is greater than the first transaction price or in a direction which is less than the first transaction price. The transaction price may rise or fall; however, it is only when the transaction price changes by an amount greater than the user defined range of data, that the invention displays the closing price on the y-axis. The invention will then display the opening price, which is outside the user defined range of data on the y-axis.

If the computer or technical analyst reads the continual stream of price data and the transaction price remains within the user defined range of data, the user defined range of data will remain unchanged, but it will still reflect price changes as they occur within this range. Time periods of minutes, days, weeks, or months, or years may pass without a change to the user defined range of data if the transaction price from the continual stream of price data remains within the user defined range of data.

Once the computer reads from the continual stream of price data the transaction price which moves outside the user defined range of data, the closing price of the previous bar will be displayed on the y-axis. The closing will always be displayed on either the indicia of the high price or low price. The indicia of the high and low prices are not critical. The preferred indicia for the high and the low prices are a high point and a low point, respectively, of a vertical bar. The preferred indicia for the opening price and closing price are a horizontal tick to the left and right, respectively, of the horizontal bar.

A new user defined range of data will not be initiated until the vertical bar under development exceeds its user defined range of data requirement. If the computer or the technical analyst reads the transaction price and it is greater than the user defined range of data, that transaction price which is outside the new user defined range of data will be displayed as the opening price adjacent to the previous user defined range of data.

### BRIEF DESCRIPTION OF THE DRAWINGS

FIG. 1 is a display of Eli Lilly's stock using the present invention wherein the user defined range of data equals $2.

FIG. 2 is a display of Eli Lilly's stock using the present invention wherein the user defined range of data equals $5.

FIG. 3 is a prior art standard daily bar chart of Eli Lilly's stock.

FIG. 4 is a prior art standard daily bar chart of Eli Lilly's stock with a technical indicator. The technical indicator is a 5/13 period moving average of the close.

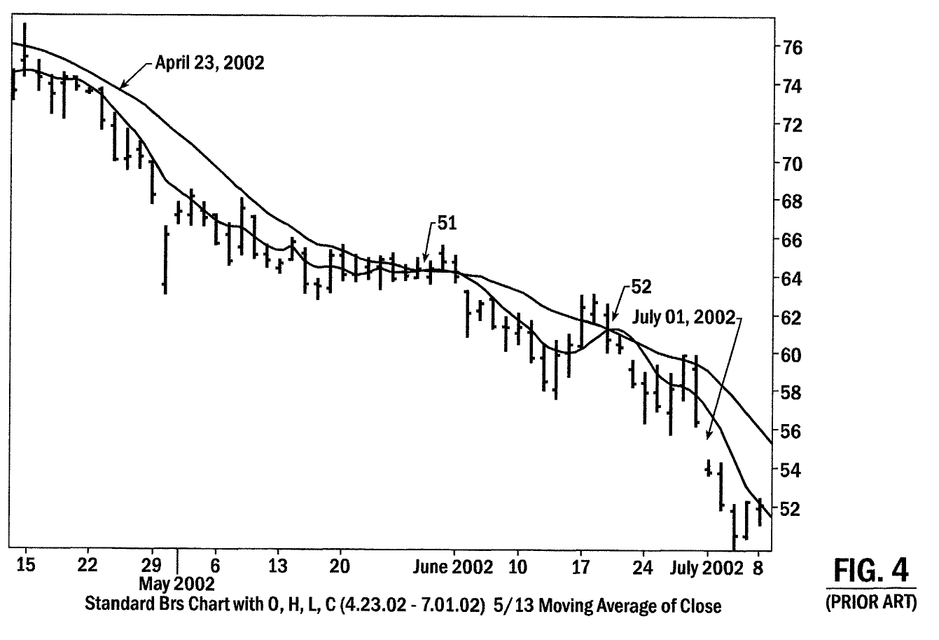

FIG. 5 is a display of Eli Lilly's stock reveals a 5/13 period moving average of the close and shows how the invention displayed no crossovers using the same study.

31 embodies the time independent x-axis

32 embodies the y-axis

33 embodies the two dollar user defined range of data

33a embodies the five dollar user defined range of data

34 embodies the transaction price which appears outside the user defined range of data

35 embodies the indicia of an opening price

36 embodies the indicia of a closing price

37 embodies the high price

38 embodies the low price

41 embodies a price gap where there is no display of trading activity between the low of

42 and the high of 43

42 embodies a bar above the price gap

43 embodies a bar below the price gap

44 embodies a bar at the beginning of price congestion wherein price trades within a narrow range over a period of time

45 embodies a bar at the end of price congestion wherein price trades within a narrow range over a period of time

46 embodies a first bar which illustrates the elimination of congestion

47 embodies a second bar which illustrates the elimination of congestion

48 embodies a third bar which illustrates the adaptation of price anomalies and eliminates the price gap

49 embodies a fourth bar which illustrates the adaptation of price anomalies

50 embodies a fifth bar which illustrates the adaptation of price anomalies

51 embodies a first example where the two 5/13 period moving average lines crossover

52 embodies a second example where the two 5/13 period moving average lines crossover

### DETAILED DESCRIPTION OF A PREFERRED EMBODIMENT AND THE BEST MODE OF PRACTICE

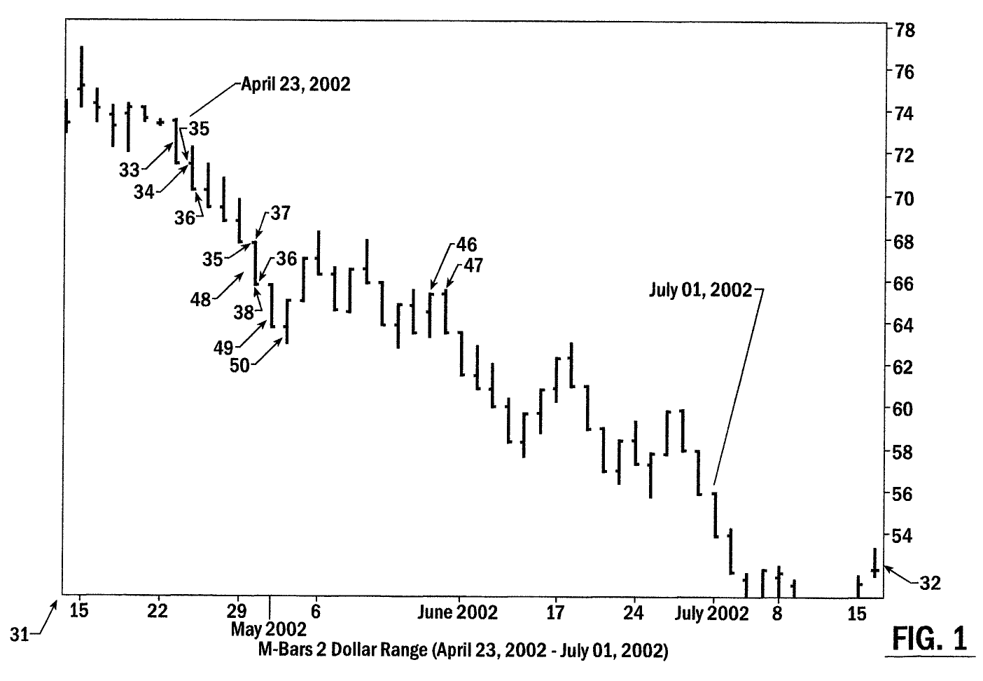

The display of Eli Lilly's stock is used to illustrate, in FIG. 1, the preferred embodiment of the present invention. In FIG. 1, the user defined range of data 33 for the display is two dollars. The display begins on Apr. 23, 2002. The first bar on the display is between $73.30 and $71.30. Since the user defined range of data 33 is two dollars, a new bar will not appear on the chart until the transaction price of Eli Lilly stock falls to $71.29 or rises to $73.31. The difference between $73.30 and $71.30 equals two dollars, the user defined range of data 33.

A second entry onto the display occurs on April 24 as Eli Lilly's stock fell to $71.29 which was less than $71.30 and outside the user defined range of data between $73.30 and $71.30. The system will display the user defined range of data 33 along with the indicia of four transaction prices. This bar comprises a high of $73.30 and a low of $71.30.

Once you exceed that user defined range of data then you add the indicia of the closing price. The opening price 34 of the new user defined range of data is indicated at $71.29. Once you exceed that user defined range of data 33 then you add the indicia of the closing price 36 to the previous bar, which in this case will be $71.30. The previous bar has a high price 37 of $73.30 a low price 38 of $71.30 and a closing price 36 of $71.30.

The user defined range of data remains at two dollars. The second bar for displaying Eli Lilly's stock has an opening price 34 at $71.29. The next bar will develop until it reaches it two dollar user defined range of data requirement.

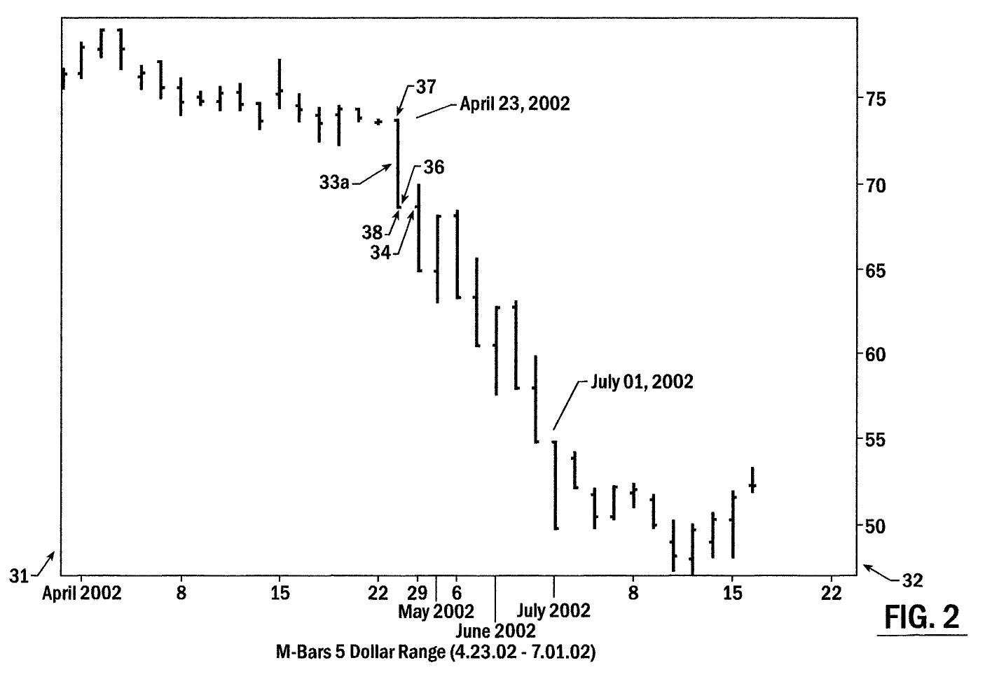

If the technical analyst decided to study Eli Lilly stock using a five dollar price range as the user defined range of data, the display of financial information would look like that which appears in FIG. 2. If the first entry is made on April 23 with the user defined range of data 33a as five dollars, the invention displays the user defined range of data between $73.30 and $68.30. Indicia of an opening price, a closing price, a high price and a low price will be displayed along with the user defined range of data between $73.30 and $68.30.

Then on April 27, the stock price fell to $68.29 which was less than $68.30. Therefore the invention will begin the display of the second user defined range of data with an opening price of $68.29. The transaction price which appears outside the user defined range of data 34 is indicated with an opening price 38. The closing price 36 of the previous bar occurs at $68.30. Once the price of Eli Lilly's stock traded outside the user defined range of data, then the invention displays the closing price of the previous bar at $68.30 and the opening price 34 of the next bar.

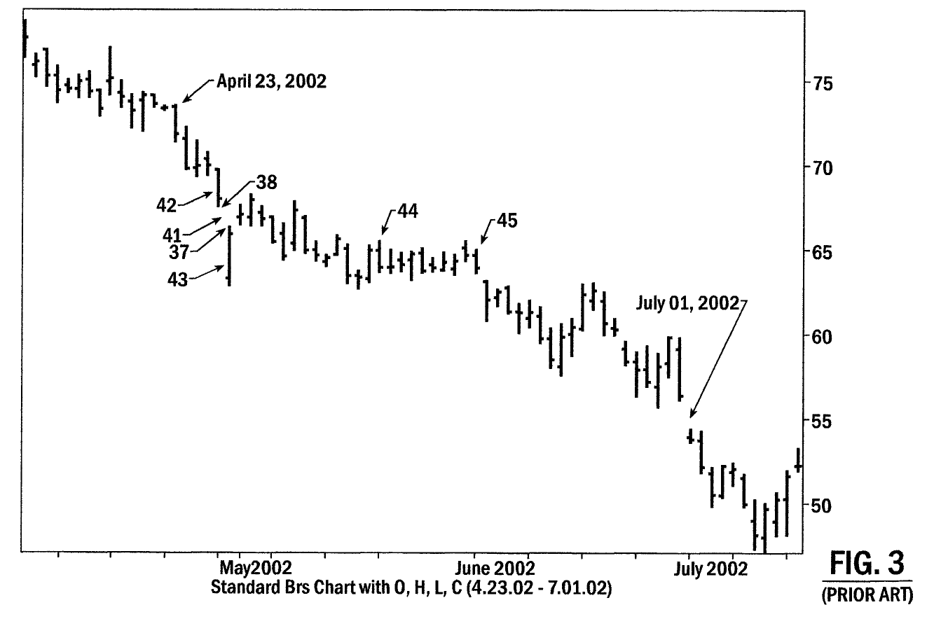

The prior art standard daily price bar of Eli Lilly's stock is shown within FIG. 3. A standard price bar for Apr. 27, 2002 is illustrated in 42. The next standard price bar is illustrated in 43. Shown between the standard daily price bars is a price gap 41, which is where price opens outside of the previous day's range and never comes back to touch the previous day's range.

The invention displays bar 48, bar 49, and bar 50 in order to eliminate the price anomaly bar 43 and price gap 41 which occurred between the prior art bars 42 and 43. The invention displayed bar 48, bar 49, and bar 50 whereas the prior art only displayed one bar 43 and a price gap 41.

The prior art in FIG. 3 also reveals a congestion are wherein price trades within a narrow price range. Note how the group of bars between 44 and 45 trade within a narrow price range.

In FIG. 1, the invention displays a first bar 46 and a second bar 47, whereas in the prior art FIG. 3 the standard bar chart displays ten bars between 44 and 45. This reveals how the invention overcomes price congestion.

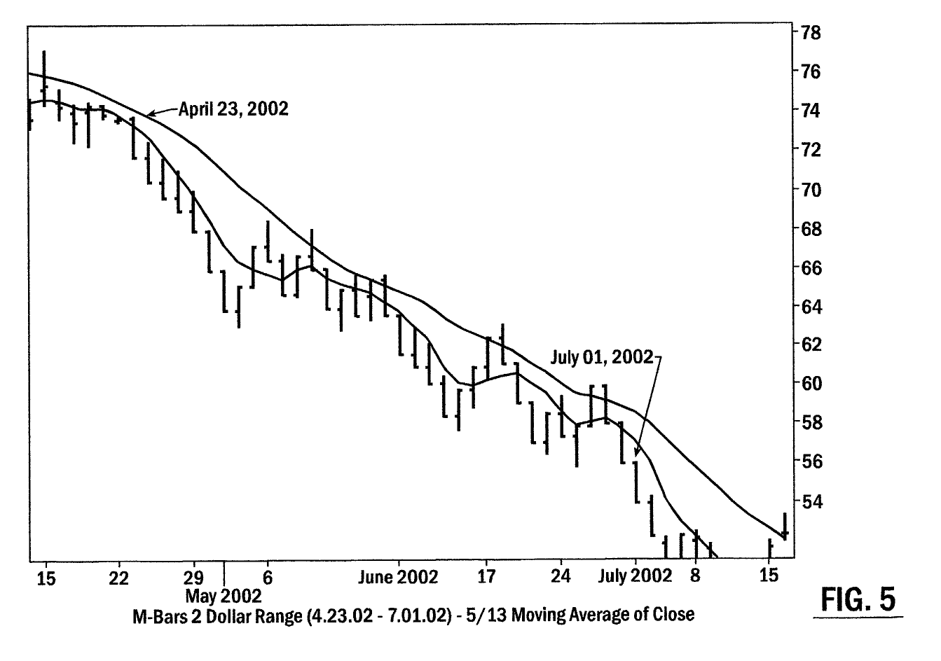

In FIG. 5, the invention would not lead a technical analyst to take positions against the trend. Therefore, there would be no indication that a long position was warranted.

In FIG. 3, the prior art, the trading volume is going to be reflected for each trading day. In FIG. 1, the invention will encompass all of the volume from the previous ten days into 2 bars, which is more reflective of actual sentiment in the market. Therefore a better indication of which way the market is likely to move will result from using the invention.

The examples illustrate the invention wherein Eli Lilly stock is displayed. Investments selected from the group consisting of securities, bonds, futures, options, and derivatives may be displayed using the same system.

The display of the invention may be generated by hand or by the use of a computer. A means for sequentially displaying on the y-axis the new user defined range of data is not critical. However, it shall preferably be accomplished by the computer and a computer software product which is sufficient to display the user defined range of data and the indicia of four transaction prices only if the transaction price appears outside the user defined range of data.

The computer software product is not critical so long as it sufficient to detect the transaction price from a database comprising the continual price stream data, communicate with a computer processor to execute software instructions, and comprise a means for compressing data files representative of an image document and display the user defined range of data comprising indicia of four transaction prices only if the transaction price appears outside the user defined range of data onto an image document including color information and/or graphical information.

A method for displaying financial information via the invention comprises the steps of selecting the time independent variable, displaying the time independent variable along the x-axis, selecting the user defined range of data, wherein the user defined range of data comprises the user defined price range, reading transaction prices from the continual stream of price data such that the continual stream of price data comprises transaction price data from physical exchange of investments selected from the group consisting of securities, bonds, futures, options, and derivatives, displaying indicia of four transaction prices on the y-axis, the transaction prices comprising indicia of high, low, opening, and closing prices, displaying the new user defined range of data only when the transaction price appears outside the user defined range of data, and repeating the method only when at least one of the transaction prices appear outside the user defined range of data. The method also includes the further steps of using a computer software product in communication with the continual price stream, using a computer processor to execute software instructions, using a memory storing program, using a means for compressing data files representative of an image document, and displaying the image document including color information and/or graphical information only if the transaction price appears outside the user defined range of data.

An alternative method for displaying financial information on a two dimensional graph using a computer involves the steps of selecting the time independent variable, displaying the time independent variable along the x-axis, selecting the user defined price range, reading transaction prices from the continual stream of price data, the continual stream of price data comprising data from physical exchange of investments selected from the group consisting of securities, cash markets, commodities, futures, options, derivatives, and any other financial transaction data, displaying the first transaction price from the continual stream of price data, displaying the user defined range of data only when the transaction price appears outside the user defined range of data, displaying indicia of four transaction prices, the transaction prices selected from the group consisting of opening, high, low, and closing prices, and displaying the new user defined price range only when at least one of the transaction prices appears outside the user defined price range.

While there is shown and described specific embodiments of this invention, the latter is not limited to the exact details of construction set forth, and the invention embraces such changes, modifications, and equivalents of the parts and their formation and arrangement as come within the purviews of the appended claims.

I claim:

1. A system using a computer for displaying financial information comprising a two dimensional graph, said two dimensional graph defined by an x-axis and a y-axis wherein said x-axis comprises a time independent variable, said y-axis comprises a user defined range of data, said user defined range of data comprising indicia of four transaction prices, a means for detecting at least one of said transaction prices outside said user defined range of data, a means for sequentially displaying on said y-axis adjacent to said user defined range of data, a new user defined range of data only when at least one of said transaction prices appears outside said user defined range of data.

2. A system using a computer for displaying financial information according to claim 1 wherein said transaction prices comprise an opening price, a low price, a high price, and a closing price; said transaction prices result from physical exchange of investments selected from the group consisting of securities, cash markets, commodities, futures, options, derivatives, and any other financial transaction data; said user defined range of data further comprising measurements selected from the group consisting of price and risk; comprising a computer software product; comprising a computer processor to execute software instructions; comprising a memory storing program; and comprising a means for compressing data files representative of an image document, said image document including color information and/or graphical information.

3. A system using a computer for displaying financial information according to claim 1 wherein said transaction prices comprise an opening price, a low price, a high price, and a closing price.

4. A system using a computer for displaying financial information according to claim 1 wherein said user defined range of data comprises a vertical bar, said vertical bar comprising indicia of four of said transaction prices, said transaction prices comprising an opening price, a low price, a high price, and a closing price.

5. A system using a computer for displaying financial information according to claim 1 wherein said user defined range of data comprises measurements selected from the group consisting of price range and risk.

6. A system using a computer for displaying financial information according to claim 1 wherein said transaction prices comprise prices resulting from physical exchange of investments selected from the group consisting of securities, cash markets, commodities, futures, options, derivatives, and any other financial transaction data.

7. A system using a computer for displaying financial information according to claim 1 further comprising a computer software product.

8. A system using a computer for displaying financial information according to claim 1 further comprising a computer processor to execute software instructions.

9. A system using a computer for displaying financial information according to claim 1 further comprising a memory storing program.

10. A system using a computer for displaying financial information according to claim 1 further comprising a means for compressing data files representative of an image document, said image document including color information and/or graphical information.

11. A system using a computer for displaying financial information comprising a two dimensional graph, said two dimensional graph defined by an x-axis and a y-axis wherein said x-axis comprises a time independent variable, said y-axis comprises a user defined range of data, said user defined range of data comprising indicia of four transaction prices, a means for detecting at least one of said transaction prices outside said user defined range of data, a means for sequentially displaying on said y-axis adjacent to said user defined range of data, a new user defined range of data only when at least one of said transaction prices changes by an amount greater than said user defined range of data.

12. A system using a computer for displaying financial information according to claim 11 wherein said transaction prices comprise an opening price, a low price, a high price, and a closing price; said transaction prices result from physical exchange of investments selected from the group consisting of securities, cash markets, commodities, futures, options, derivatives, and any other financial transaction data; said user defined range of data further comprising measurements selected from the group consisting of price and risk; comprising a computer software product; comprising a computer processor to execute software instructions; comprising a memory storing program; and comprising a means for compressing data files representative of an image document, said image document including color information and/or graphical information.

13. A system using a computer for displaying financial information according to claim 11 wherein said transaction prices comprise an opening price, a low price, a high price, and a closing price.

14. A system using a computer for displaying financial information according to claim 11 wherein said indicia of said transaction prices comprise a vertical bar comprising a first horizontal tick comprising an opening price and a second horizontal tick comprising a closing price

15. A system using a computer for displaying financial information according to claim 11 wherein said user defined range of data comprises measurements selected from the group consisting of price range and risk.

16. A system using a computer for displaying financial information according to claim 11 wherein said transaction prices comprise prices resulting from physical exchange of investments selected from the group consisting of securities, cash markets, commodities, futures, options, derivatives, and any other financial transaction data.

17. A system using a computer for displaying financial information according to claim 11 further comprising a computer software product.

18. A system using a computer for displaying financial information according to claim 11 further comprising a computer processor to execute software instructions.

19. A system using a computer for displaying financial information according to claim 11 further comprising a memory storing program.

20. A system using a computer for displaying financial information according to claim 11 further comprising a means for compressing data files representative of an image document, said image document including color information and/or graphical information.

21. A system using a computer for displaying financial information according to claim 11 wherein said transaction prices result from physical exchange of investments selected from the group consisting of securities, cash markets, commodities, futures, options, derivatives, and any other financial transaction data; said user defined range of data comprise measurements selected from the group consisting of price and risk; said transaction prices comprise an opening price, a closing price, a low price, and a high price; comprising a computer software product; comprising a computer processor to execute software instructions; comprising a memory storing program; and comprising a means for compressing data files representative of an image document, said image document including color information and/or graphical information.

22. A system using a computer for displaying financial information comprising a two dimensional graph; said two dimensional graph defined by an x-axis and a y-axis wherein said x-axis comprises a time independent variable; said y-axis comprises a user defined price range, said user defined price range comprise indicia of four transaction prices; a means for detecting said transaction prices outside said user defined price range; and a means for sequentially displaying on said y-axis adjacent to said user defined price range, a new user defined price range only when said transaction price changes by an amount greater than said user defined price range.

23. A system using a computer for displaying financial information according to claim 22 wherein said transaction prices result from physical exchange of investments selected from the group consisting of securities, cash markets, commodities, futures, options, derivatives, and any other financial transaction data; comprising a computer software product; comprising a computer processor to execute software instructions; comprising a memory storing program; and comprising a means for compressing data files representative of an image document; said image document including color information and/or graphical information.

24. A method for displaying financial information using a computer comprising the steps of
a. selecting a time independent variable,
b. displaying said time independent variable along an x-axis,
c. selecting a user defined range of data,
d. displaying said user defined range of data on a y-axis
e. reading transaction prices from physical exchange of investments selected from the group consisting of securities, cash markets, commodities, futures, options, derivatives, and any other financial transaction data,
f. detecting said transaction prices outside said user defined range of data
g. displaying said transaction price on said y-axis only if said transaction price appears outside said user defined range of data
h. displaying indicia of four of said transaction prices on said y-axis,
i. displaying a new user defined range of data only when at least one of said transaction prices appears outside said user defined range of data,
j. repeating steps (a) through (i) only when at least one of said transaction prices appears outside said user defined range of data.

25. A method for displaying financial information using a computer according to claim 24 further comprising the steps of using a computer software product; using a computer processor to execute software instructions; using a memory storing program; using a means for compressing data files representative of an image document, said image document including color information and/or graphical information.

26. A method for displaying financial information using a computer according to claim 24 further comprising the steps of displaying the indicia of an opening price when the transaction price appears outside said user defined range of data, displaying the indicia of a closing price on the user defined range of data, displaying the indicia of a high price on the user defined range of data and displaying the indicia of the low price said user defined range of data.

27. A method for displaying financial information using a computer according to claim 24 further comprising the steps of displaying the indicia of an opening price, a closing price, a high price, and a low price on said user defined range of data as a vertical bar with horizontal ticks to the left and right of said vertical bar.

28. A method for displaying financial information using a comprising the steps of
a. selecting a time independent variable,
b. displaying said time independent variable along an x-axis,
c. selecting a user defined range of data
d. displaying said user defined range of data on a y-axis,
e. reading transaction prices from physical exchange of investments selected from the group consisting of securities, cash markets, commodities, futures, options, derivatives, and any other financial transaction data,
f. detecting transaction prices which change by an amount greater than or equal to said user defined range of data
g. displaying a new user defined range of data only if at least one of said transaction prices changes by an amount greater than said user defined range of data,
h. displaying indicia of four of said transaction prices on said y-axis
i. repeating steps (a) through (h) only when at least one of said transaction prices changes by an amount greater than said user defined range of data.

29. A method according to claim 328 further comprising the steps of using a computer software product, a computer processor to execute software instructions, a memory storing program, and a means for compressing data files representative of an image document, said image document including color information and/or graphical information.

30. A method for displaying financial information using a computer comprising the steps of
a. selecting a time independent variable,
b. displaying said time independent variable along an x-axis,
c. selecting a user defined price range,
d. displaying said user defined price range on a y-axis,
e. reading transaction prices from physical exchange of investments selected from the group consisting of securities, cash markets, commodities, futures, options, derivatives, and any other financial transaction data,
f. detecting said transaction prices outside said user defined price range
g. displaying a new user defined price range only when at least one of said transaction prices appears outside said user defined price range,
h. displaying indicia of four of said transaction prices on said y-axis
i. repeating steps (a) through (h) only when at least one of said transaction prices appears outside said user defined price range.

31. A method for displaying financial information using a computer according to claim 30 further comprising the steps of using a computer software product, a computer processor to execute software instructions, a memory storing program, and a means for compressing data files representative of an image document, said image document including color information and/or graphical information.

32. A method for displaying financial information using a computer comprising the steps of
a. selecting a time independent variable,
b. displaying said time independent variable along an x-axis,
c. selecting a user defined price range,
d. displaying said user defined price range on a y-axis,
e. reading transaction prices from physical exchange of investments selected from the group consisting of securities, cash markets, commodities, futures, options, derivatives, and any other financial transaction data,
f. detecting said transaction prices outside said user defined price range
g. displaying a new user defined price range only when at least one of said transaction prices changes by an amount greater than said user defined price range,
h. displaying indicia of four of said transaction prices on said y-axis
i. repeating steps (a) through (h) only when at least one of said transaction prices changes by an amount greater than said user defined price range.

33. A method for displaying financial information using a computer according to claim 32 further comprising the steps of using a computer software product, a computer processor to execute software instructions, a memory storing program, and a means for compressing data files representative of an image document, said image document including color information and/or graphical information.

34. A method for displaying financial information using a computer comprising the steps of
a. selecting a time independent variable,
b. displaying said time independent variable along an x-axis,
c. selecting a user defined price range,
d. displaying said user defined price range on a y-axis,
e. reading transaction prices from physical exchange of investments selected from the group consisting of securities, cash markets, commodities, futures, options, derivatives, and any other financial transaction data,
f. reading transaction prices from physical exchange of investments selected from the group consisting of securities, cash markets, commodities, futures, options, derivatives, and any other financial transaction data,
g. detecting said transaction prices outside said user defined price range,
h. displaying a new user defined price range only when at least one of said transaction prices exceeds said user defined price range requirement,
i. displaying indicia of four of said transaction prices on said y-axis
j. repeating steps (a) through (i) only when at least one of said transaction prices exceeds said user defined price range requirement.

35. A method for displaying financial information using a computer according to claim 34 further comprising the steps of using a computer software product, a computer processor to execute software instructions, a memory storing program, and a means for compressing data files representative of an image document, said image document including color information and/or graphical information.

36. A system for displaying financial information comprising a two dimensional graph, said two dimensional graph defined by an x-axis and a y-axis wherein said x-axis comprises a time independent variable, said y-axis comprises a user defined range of data, said user defined range of data comprising indicia of four transaction prices, a means for detecting at least one of said transaction prices outside said user defined range of data, a means for sequentially displaying on said y-axis adjacent to said user defined range of data, a new user defined range of data only when at least one of said transaction prices appears outside said user defined range of data.

37. A system for displaying financial information according to claim 36 wherein said transaction prices comprise an opening price, a low price, a high price, and a closing price; said transaction prices result from physical exchange of investments selected from the group consisting of securities, cash markets, commodities, futures, options, derivatives, and any other financial transaction data; and said user defined range of data further comprising measurements selected from the group consisting of

38. A system using a computer for displaying financial information according to claim 36 wherein said transaction prices comprise an opening price, a low price, a high price, and a closing price.

39. A system for displaying financial information according to claim 36 wherein said user defined range of data comprises a vertical bar, said vertical bar comprising indicia of four of said transaction prices, said transaction prices comprising an opening price, a low price, a high price, and a closing price.

40. A system for displaying financial information according to claim 36 wherein said user defined range of data comprises measurements selected from the group consisting of price range and risk.

41. A system for displaying financial information according to claim 36 wherein said transaction prices comprise prices resulting from physical exchange of investments selected from the group consisting of securities, cash markets, commodities, futures, options, derivatives, and any other financial transaction data.
